(19) United States
(12) Patent Application Publication
(10) Pub. No.: US 2026/0104863 A1
(43) Pub. Date: Apr. 16, 2026

(54) METHOD AND SYSTEM FOR GENERATING FINE-TUNED CODE FOR LARGE LANGUAGE MODELS (LLMS)

(71) Applicant: HCL Technologies Limited, New Delhi (IN)

(72) Inventors: Harikrishna C. Warrier, Bengaluru (IN); Yogesh Gupta, Noida (IN); Dhanyamraju S U M Prasad, Hyderabad (IN)

(21) Appl. No.: 19/086,302

(22) Filed: Mar. 21, 2025

(30) Foreign Application Priority Data
Oct. 11, 2024 (IN) 202411077389

(51) Int. Cl. G06F 8/35; G06F 21/10

(52) U.S. Cl. CPC G06F 8/35; G06F 21/1065

(57) ABSTRACT

This disclosure relates to method and system for generating fine-tuning code for Large Language Models (LLMs). The method may include identifying one or more Intellectual Property (IP) functions within a code in a code file. Upon identifying the one or more IP functions, the method may further include flattening each of the one or more IP functions by replacing each of the one or more IP functions with a corresponding native reference code. The method may further include assigning a unique identifier to the corresponding native reference code associated with each of the one or more IP functions. The method further includes generating a fine-tuned data file comprising the fine-tuned code corresponding to the code file, in response to assigning.

### TECHNICAL FIELD

This disclosure relates generally to Large Language Models, and more particularly to method and system for generating fine-tuned code for LLMs.

### BACKGROUND

Fine-tuning a Large Language Model (LLM) means training a pre-trained model on a specific data set. Fine-tuning of the LLM is gaining popularity with enterprises. The fine-tuning of the LLM is done using a large number of use cases. The use cases involving the fine-tuning may include a code generation, a code completion, a code translation, etc. In all the use cases, the enterprises must fine-tune the pre-trained model with a code. The code may potentially be the Intellectual Property (IP) of the enterprises. In this case, when the LLM generates the code, the IP functions embedded within the code may get generated. The generation of IP functions may be a potential security breach. The enterprises may train the LLM with proprietary IP functions resulting in generation of the IP functions.

There is, therefore, a need in the present state of art for approaches to ensure that generation of IP functions in the code may be controlled.

### SUMMARY

In one embodiment, a method for generating fine-tuned code for large language models (LLMs) is disclosed. In one example, the method may include identifying one or more Intellectual Property (IP) functions within a code in a code file. The code file may be received as an input from a user. Upon identifying the one or more IP functions, the method may further include flattening each of the one or more IP functions by replacing each of the one or more IP functions with a corresponding native reference code. The flattening of each of the one or more IP functions is iteratively performed until no IP function is left in the code. The method may further include assigning a unique identifier to the corresponding native reference code associated with each of the one or more IP functions. The method may include generating a fine-tuned data file including the fine-tuned code corresponding to the code in the code file, in response to assigning.

In another embodiment, a system for generating fine-tuned code for LLMs is disclosed. In one example, the system may include a processor and a computer-readable medium communicatively coupled to the processor. The computer-readable medium may store processor-executable instructions, which, on execution, may cause the processor to identify one or more IP functions within a code in a code file. The code file may be received as an input from a user. Upon identifying the one or more IP function, the processor-executable instructions, on execution, may further cause the processor to flatten each of the one or more IP functions by replacing each of the one or more IP functions with a corresponding native reference code. The flattening of each of the one or more IP functions is iteratively performed until no IP function is left in the code. The processor-executable instructions, on execution, may further cause the processor to assign a unique identifier to the corresponding native reference code associated with each of the one or more IP functions. The processor-executable instructions, on execution, may further cause the processor to generate a fine-tuned data file that includes the fine-tuned code corresponding to the code in the code file, in response to assigning.

In another embodiment, a non-transitory computer-readable medium storing computer-executable instructions for generating fine-tuned code for LLMs is disclosed. In one example, the stored instructions, when executed by a processor, may cause the processor to perform operations including identifying one or more IP functions within a code in a code file. The code file is received as an input from a user. Upon identifying the one or more IP functions, the operations may further include flattening each of the one or more IP functions by replacing each of the one or more IP functions with a corresponding native reference code. The flattening of each of the one or more IP functions is iteratively performed until no IP function is left in the code. The operations may further include assigning a unique identifier to the corresponding native reference code associated with each of the one or more IP functions. The operations may further include generating a fine-tuned data file that includes the fine-tuned code corresponding to the code file, in response to assigning.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for generating fine-tuned code for Large Language Models (LLMs), in accordance with some embodiments.

FIG. 2 illustrates a functional block diagram of an exemplary system for generating fine-tuned code for LLMs, in accordance with some embodiments.

FIG. 3 illustrates a flow diagram of an exemplary process for generating fine-tuned code for LLMs, in accordance with some embodiments.

FIG. 4 illustrates a flow diagram of an exemplary process for iteratively performing flattening of Intellectual Property (IP) functions, in accordance with some embodiments.

FIG. 5 illustrates a flow diagram of an exemplary control logic for generating a non-IP code for LLMs, in accordance with some embodiments.

FIG. 6 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

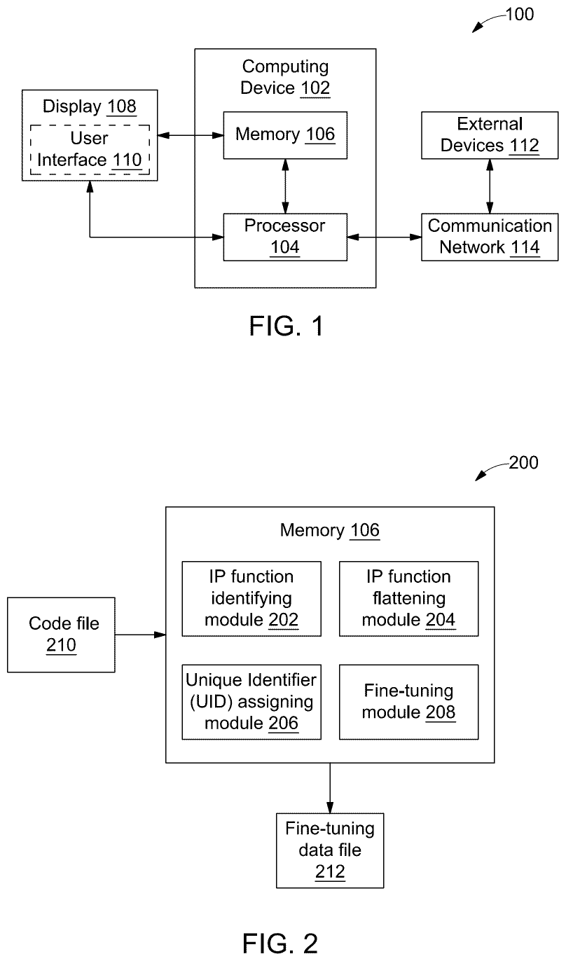

Referring now to FIG. 1, an exemplary system 100 for generating fine-tuned code for Large Language Models (LLMs) is illustrated, in accordance with some embodiments. The fine-tuning may be done to adapt a pre-trained model for specific tasks or use case. The system 100 may include a computing device 102 (for example, a server, a desktop, a laptop, a notebook, a netbook, a tablet, a smartphone, a mobile phone, or any other computing device), in accordance with some embodiments. The computing device 102 may generate a fine-tuned code for LLMs that ensure no IP function (i.e., a function specific to a particular device or an environment that should not be disclosed) may be generated. The fine-tuned code may include information related to the IP functions as a general-purpose code. By way of an example, a function opens a browser in a specific way which should not be exposed. Therefore, the specific way to open the browser may be the IP function. Not exposing the IP function may ensure that any information related to hardware or environment (the environment on which the IP function is running) is not disclosed. It should be noted that the IP functions may be encapsulated as an IP macro or IP sub-routine.

As will be described in greater detail in conjunction with FIG. 2-FIG. 4, the computing device 102 may identify one or more IP functions within a code in a code file. A code, for example, may be a code specific to an operating a device, a code to control function, a code for testing a device, or the like. It should be noted that the code file may be received as an input from a user. Upon identifying the one or more IP functions, the computing device 102 may flatten each of the one or more IP functions by replacing each of the one or more IP functions with a corresponding native reference code. Flattening IP function may translate to expanding the IP function to an actual code within the IP function. The flattening of each of the one or more IP functions may be iteratively performed until no IP function is left in the code. The computing device 102 may further assign a unique identifier to the corresponding native reference code associated with each of the one or more IP functions. It should be noted that the unique identifier may be a numeric or alphanumeric string that may be associated with a single entity within a system. The unique identifiers may make it possible to provide an address to the entity, in order to access the entity. The computing device 102 may further generate a fine-tuned data file including the fine-tuned code corresponding to the code in the code file, in response to assigning.

In some embodiments, the computing device 102 may include one or more processors 104 and a memory 106. Further, the memory 106 may store instructions that, when executed by the one or more processors 104, cause the one or more processors 104 to generate fine-tuned code for LLMs, in accordance with aspects of the present disclosure. The memory 106 may also store various data (for example, a code file, an IP function, a native reference code, a unique identifier, a configuration file, and the like) that may be captured, processed, and/or required by the system 100. The memory 106 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.).

The system 100 may further include a display 108. The system 100 may interact with a user via a user interface 110 accessible via the display 108. The system 100 may also include one or more external devices 112. In some embodiments, the computing device 102 may interact with the one or more external devices 112 over a communication network 114 for sending or receiving various data. The external devices 112 may include, but may not be limited to, a remote server, a digital device, or another computing system.

Referring now to FIG. 2, a functional block diagram of an exemplary system 200 for generating fine-tuned code for LLMs is illustrated, in accordance with some embodiments. FIG. 2 is explained in conjunction with FIG. 1. The memory 106 may include an IP function identifying module 202, an IP function flattening module 204, a Unique Identifier (UID) assigning module 206, and a fine-tuning module 208.

The IP function identifying module 202 may receive a code file 210 as an input from a user. It should be noted that the code file 210 may include a code. Upon receiving the code file 210, the IP function identifying module 202 may identify one or more IP functions within the code. To identify the one or more IP functions, the IP function identifying module 202 may analyze the code within the received code file 210, based on at least one of a pre-processing technique and a configuration file. The pre-processing technique may include assigning the IP functions with a pre-processing directive. The pre-processing directives may include the statements generally starting with the hashtag symbol (“#”). The pre-processing directives may be responsible for adding header files, macros, libraries and modules before a primary function. In case of IP functions, the pre-processing directives may imply that the function is an IP function, and therefore, should not be exposed.

Additionally, the IP function identifying module 202 may receive the configuration file corresponding to the code file 210 as an input. It should be noted that the configuration file may be generated by the user. The configuration file may include relatively more structured pattern of the IP functions such as the key attributes associated with an IP environment, the key attributes associated with an IP declaration, the key attributes associated with a comment of the code, and a signature pattern compared to the pre-processing directives. By way of an example, a Device Automation Testing (DAT) may be a product used in testing of a plurality of devices. The IP functions of the DAT may include DAT as the signature pattern. For example, DAT browser, DAT opening, DAT polling, or the like. Therefore, the patterns related to DAT may be included in the configuration file. Similarly, the attributes associated with comments of the code, attributes associated with the IP environment, key attributes associated with IP declarations may be included in the configuration file. Further, the pre-processing directives may use the configuration file to identify the IP functions. It should be noted that the configuration file may further smoothen the process to identify the IP functions.

Upon identifying the one or more IP functions, the IP function flattening module 204 may flatten each of the one or more IP functions in the code. The flattening may include iteratively replacing each of the one or more IP functions with a corresponding native reference code until no IP function is left in the code. To iteratively replace each of the one or more IP functions, the IP function identifying module 202 may analyze each IP function of the one or more IP functions in order to identify one or more sub-IP functions within each IP function. Once the sub-IP functions are identified, the IP function flattening module 204 may flatten each of the one or more sub-IP functions by replacing each sub-IP function of the one or more sub-IP functions with a corresponding native reference code.

Further, the IP function identifying module 202 may analyze each sub-IP function of the one or more sub-IP functions to identify one or more subsequent sub-IP functions within each sub-IP function. Upon identifying the one or more subsequent sub-IP functions, the IP function flattening module 204 may flatten each of the one or more subsequent sub-IP functions by replacing each subsequent sub-IP function of the one or more subsequent sub-IP functions with a corresponding native reference code. Additionally, the IP function identifying module 202 may identify at least one of a comment or a document string associated with each IP function of the one or more IP functions. In response to identifying, the IP function flattening module 204 may replace each of the at least one of the comment or the document string with a corresponding native comment or a corresponding native document string, respectively.

Further, the UID assigning module 206 may assign a unique identifier (UID) to the corresponding native reference code associated with each of the one or more IP functions. In response to assigning, the fine-tuning module 208 may generate a fine-tuned data file 212. It should be noted that the fine-tuned data file 212 may include a fine-tuned code corresponding to the code in the code file 210. The code may not include any IP functions. The fine-tuned code in the fine-tuned data file 212 may be utilized for fine-tuning an LLM.

It should be noted that all such aforementioned modules 202-208 may be represented as a single module or a combination of different modules. Further, as will be appreciated by those skilled in the art, each of the modules 202-208 may reside, in whole or in parts, on one device or multiple devices in communication with each other. In some embodiments, each of the modules 202-208 may be implemented as dedicated hardware circuit comprising custom application-specific integrated circuit (ASIC) or gate arrays, off-the-shelf semiconductors such as logic chips, transistors, or other discrete components. Each of the modules 202-208 may also be implemented in a programmable hardware device such as a field programmable gate array (FPGA), programmable array logic, programmable logic device, and so forth. Alternatively, each of the modules 202-208 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for generating fine-tuned code for LLMs. For example, the exemplary system 100 and the associated computing device 102 may generate fine-tuned code for LLMs by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

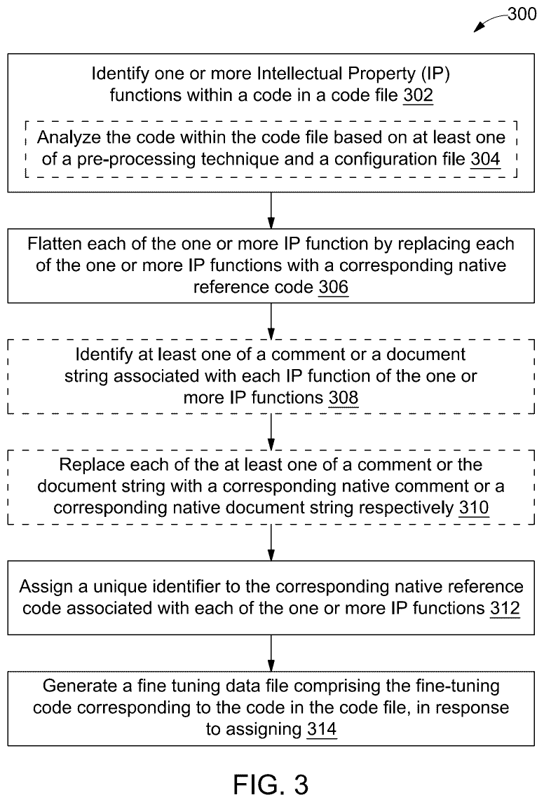

Referring now to FIG. 3, an exemplary process 300 for generating fine-tuned code for LLMs is depicted via a flowchart, in accordance with some embodiments. FIG. 3 is explained in conjunction with FIG. 2. The process 300 may be implemented by the computing device 102 of the system 100. The process 300 may include identifying one or more IP functions within a code in a code file (for example, the code file 210), at step 302. The code file may be received as an input from a user. To identify one or more IP functions, the step 302 of the process 300 may include analyzing the code within the received code file based on at least one of a pre-processing technique and a configuration file, at step 304. The configuration file corresponding to the code file is generated by the user. The configuration file includes domain specific information associated with components of a framework.

By way of an example, the IP function identifying module 202 may receive a code file 210 as an input from the user. The code file 210 may include the code. The IP function identifying module 202 may analyze the code in the code file 210. Upon analyzing the code, the IP function identifying module 202 may identify two IP functions. The first IP function may be “IP_function_1”, and the second IP function may be “IP_function_2”. Further, the UID assigning module 206 may assign a unique identifier to the corresponding reference code associated with the “IP_function_1”, and the “IP_function_2”. Finally, the fine-tuning module 208 may generate the fine-tuned data file (for example, the fine-tuned code file 212) to fine-tune the LLM.

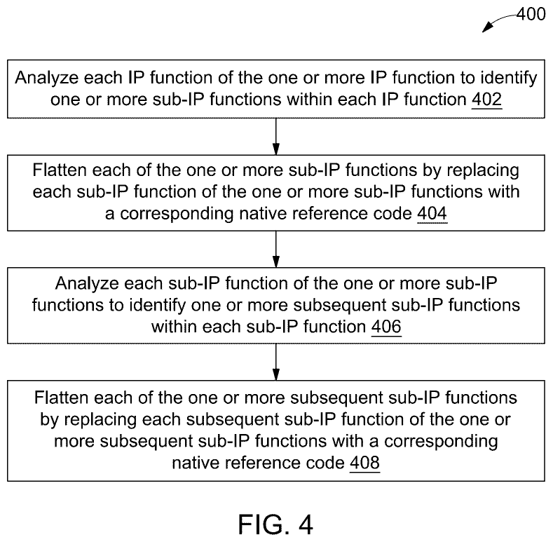

Upon identifying the one or more IP functions, the process 300 may include flattening each of the one or more IP functions by replacing each of the one or more IP functions with a corresponding native reference code, at step 306. It should be noted that the flattening of each of the one or more IP functions may be iteratively performed until no IP function is left in the code. Iteratively performing flattening of each of the one or more IP function is explained in greater detail in conjunction with FIG. 4. Additionally, the process 300 may include identifying at least one of a comment or a document string associated with each IP function of the one or more IP functions, at step 308. In response to identifying, the process 300 may include replacing each of the at least one of the comment or the document string with a corresponding native comment or a corresponding native document string respectively, at step 310. Further, the process 300 may assign a UID to the corresponding native reference code associated with the each of the one or more IP functions, at step 312. Finally, the process 300 may include generating a fine-tuned data file (for example, the fine-tuned data file 212) including the fine-tuned code corresponding to the code in the code file, in response to assigning, at step 314. The fine-tuned code corresponds to a generic code with no IP functions. The fine-tuned code within the fine-tuned data file may be utilized for fine-tuning an LLM. The fine-tuned code may correspond to a generic code with no IP functions.

In continuation of the example above, once the IP functions are identified, the IP function flattening module 204 may flatten the “IP_function_1”, and the “IP_function_2”. The IP function flattening module 204 may flatten the “IP_function_1” by replacing the “IP_function_1” with the corresponding native reference code. Similarly, the IP function flattening module 204 may flatten the “IP_function_2” by replacing the “IP_function_2” with the corresponding native reference code. The IP function flattening module 204 may flatten the IP functions until no IP function is left in the code. The IP function flattening module 204 may iteratively perform flattening of the “IP_function_1”,and the “IP_function_2” until there is no IP function left in the code. Further, the UID assigning module 206 may assign a unique identifier to the corresponding reference code associated with the “IP_function_1”, and the “IP_function_2”. Finally, the fine-tuning module 208 may generate the fine-tuned data file (for example, the fine-tuned code file 212) to fine-tune the LLM.

Referring now to FIG. 4, an exemplary process 400 for iteratively performing flattening of each of the one or more IP functions is depicted via a flow chart, in accordance with some embodiments of the present disclosure. FIG. 4 is explained in conjunction with FIG. 2 and FIG. 3. The process 400 may be implemented by the computing device 102. Flattening of each of the one or more IP functions at step 306 of FIG. 3 may be performed iteratively until no IP function is left in the code. To iteratively perform flattening of each of the one or more IP functions, the process 400 may analyze each IP function of the one or more IP functions to identify one or more sub-IP functions within each IP function, at step 402. Upon identifying the one or more sub-IP functions, the process 400 may include flattening each of the one or more sub-IP functions by replacing each sub-IP function of the one or more sub-IP functions with a corresponding native reference code, at step 404. Further, the process 400 may include analyzing each sub-IP function of the one or more sub-IP functions to identify one or more subsequent sub-IP functions within each sub-IP function, at step 406. Upon identifying the one or more subsequent sub-IP functions, the process 400 may include flattening each of the one or more subsequent sub-IP functions by replacing each subsequent sub-IP function of the one or more subsequent sub-IP functions with a corresponding native reference code, at step 408.

In continuation of the example given in conjunction with FIG. 3, in order to iteratively perform flattening of the “IP_function_1”, and the “IP_function_2”, the IP function identifying module 202 may analyze the “IP_function_1”, and the “IP_function_2” to identify one or more sub-IP functions. The IP function identifying module 202 may identify no sub-IP function in the “IP_function_1” and need not further flatten the IP function. On the other hand, the IP function identifying module 202 may identify two sub-IP functions in the “IP_function_2”. The first sub-IP functions may be “sub_IP_function_1”, and the second sub-IP function may be “sub_IP_function_2”. Once the sub-IP functions are identified, the IP function flattening module 204 may flatten the “sub_IP_function_1” and the “sub_IP_function_2” by replacing the “sub_IP_function_1” and the “sub_IP_function_2”with the corresponding native reference code.

Further, the IP function identifying module 202 may analyze the “sub_IP_function_1”, and the “sub_IP_function_2” to identify subsequent sub-IP functions. The IP function identifying module 202 may not identify subsequent sub-IP functions in the “sub_IP_function_1”, therefore, the IP function flattening module 204 need not flatten the “sub_IP_function_1” any further. On the other hand, the IP function identifying module 202 may identify a subsequent sub-IP function, i.e., “subsequent_sub_IP_function_1” within the sub-IP function “sub_IP_function_2”. Upon identifying the “subsequent_sub_IP_function_1”, the IP function flattening module 204 may flatten the “subsequent_sub_IP_function_1” by replacing the “subsequent_sub_IP_function_1” with the corresponding native reference code. Further, the UID assigning module 206 may assign the UID to the corresponding native reference code associated with the “sub_IP_function_1”, “sub_IP_function_2”, and “subsequent_sub_IP_function_1”. Further, the fine-tuning module 208 may generate the fine-tuned data file (for example, the fine-tuned code file 212). The fine-tuned data file may include the fine-tuned code corresponding to the code in the code file 210

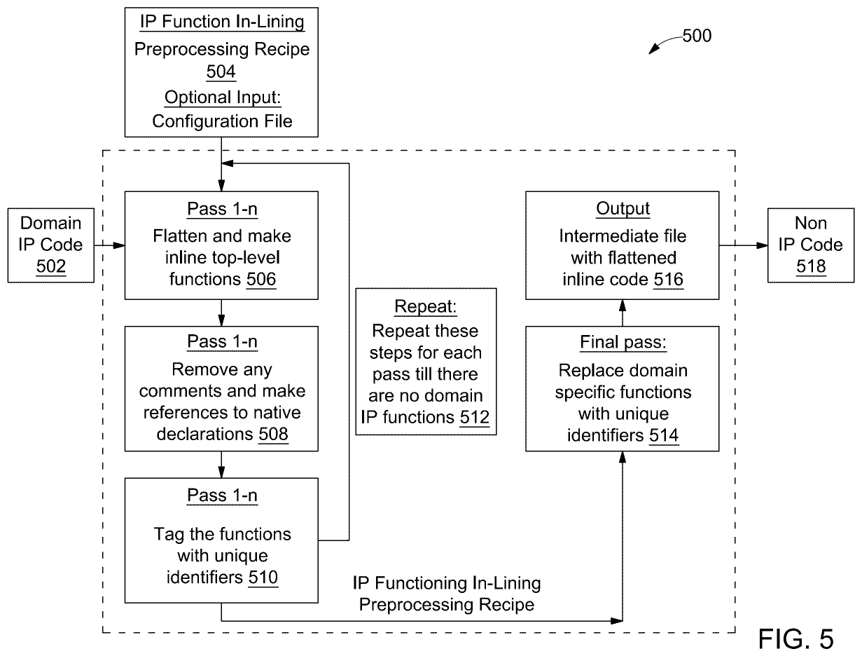

Referring now to FIG. 5, a flow diagram of an exemplary control logic 500 for generating a non-IP code (or the fine-tuned code) for LLMs is illustrated, in accordance with some embodiments. FIG. 5 is explained in conjunction with FIG. 2-FIG. 4. The control logic 500 may be implemented by the computing device 102. The control logic 500 may include receiving, by the IP function identifying module 202, a code file (for example, the code file 210) as an input from a user. The code file may include domain IP code 502, (or “code” as referred in aforementioned paragraphs). Additionally, the control logic 500 may include receiving, by the IP function identifying module 202, a configuration file 504 as an input from the user. The configuration file 504 may further smoothen the process of generating a fine-tuned code for LLMs. The configuration file 504 may include the IP functions and the attributes associated with the IP functions, routines, and other IP related information that may need to be protected from being exposed. The configuration file 504 may include controlling the mechanism to identify domain IP functions (or ““IP functions” as referred in aforementioned paragraphs). The configuration file 504 may include signature patterns or names of IP functions and routines, key attributes or entities associated with code comments included in IP functions, key attributes or entities associated with IP environment, and key attributes or entities associated with domain IP declarations.

The control logic 500 may include identifying, by the IP function identifying module 202, the IP functions in the code and then flattening, by the IP function flattening module 204, the identified IP functions by replacing the IP functions with an inline code (referred to as “a native reference code”), at step 506. For example, the code may include an IP function “domain_train_model”. The “domain_train_model” may train a machine learning algorithm. While flattening the IP functions, the control logic 500 may then include identifying, by the IP function identifying module 202, at least one of a comment or docstrings associated with the code 502 and then may include replacing, by the IP function flattening module 204, each of the at least one of the comment or docstrings with the native reference code associated with the comments or the docstrings, at step 508. In other words, data structures, variables, arguments, or the like associated with the comments or the docstrings are mapped to the corresponding native references. The control logic 500 may then include tagging, by the UID assigning module 206, the corresponding native reference code with the UIDs in order to use the UIDs further in the rest of the code, at step 510. By tagging the native reference codes with the UIDs, the calling and callable code may get the corresponding links to the IP functions without exposing the framework.

The control logic 500 may include repeating the steps 506-510 until no IP function is left in the flattened code 502, at step 512. In other words, the steps 506-510 may constitute a pass (or iteration) until no IP functions are left in the flattened code. For example, the “domain_train_model” may include a sub-IP function “domain_hyperparam_search”. The “domain_hyperparam_search” may search the hyper parameter to optimize the algorithm hyper parameters. After all the IP functions are flattened, the control logic 500 may include replacing, by the UID assigning module 206, the IP functions with the UIDs, at step 514. Further, the control logic 500 may include creating, by the fine-tuning module 208, a plurality of intermediate file (for example, the fine-tuned data file 212) including a fine-tuned code corresponding to the code in the domain IP code 502, at step 516. The plurality of intermediate file may include the code excluding the IP functions i.e., a non-IP code 518. The non-IP code 518 may be associated with an original functionality of the code.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

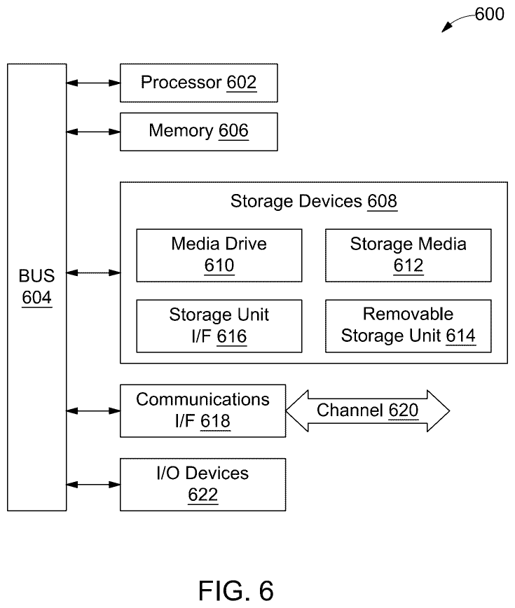

The disclosed methods and systems may be implemented on a conventional or a general-purpose computer system, such as a personal computer (PC) or server computer. Referring now to FIG. 6, an exemplary computing system 600 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 600 may represent, for example, a user device such as a desktop, a laptop, a mobile phone, personal entertainment device, DVR, and so on, or any other type of special or general-purpose computing device as may be desirable or appropriate for a given application or environment. The computing system 600 may include one or more processors, such as a processor 602 that may be implemented using a general or special purpose processing engine such as, for example, a microprocessor, microcontroller or other control logic. In this example, the processor 602 is connected to a bus 604 or other communication medium. In some embodiments, the processor 602 may be an Artificial Intelligence (AI) processor, which may be implemented as a Tensor Processing Unit (TPU), or a graphical processor unit, or a custom programmable solution Field-Programmable Gate Array (FPGA).

The computing system 600 may also include a memory 606 (main memory), for example, Random Access Memory (RAM) or other dynamic memory, for storing information and instructions to be executed by the processor 602. The memory 606 also may be used for storing temporary variables or other intermediate information during execution of instructions to be executed by the processor 602. The computing system 600 may likewise include a read only memory (“ROM”) or other static storage device coupled to bus 604 for storing static information and instructions for the processor 602.

The computing system 600 may also include a storage device 608, which may include, for example, a media drive 610 and a removable storage interface. The media drive 610 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 612 may include, for example, a hard disk, magnetic tape, flash drive, or other fixed or removable medium that is read by and written to by the media drive 610. As these examples illustrate, the storage media 612 may include a computer-readable storage medium having stored therein particular computer software or data.

In alternative embodiments, the storage devices 608 may include other similar instrumentalities for allowing computer programs or other instructions or data to be loaded into the computing system 600. Such instrumentalities may include, for example, a removable storage unit 614 and a storage unit interface 616, such as a program cartridge and cartridge interface, a removable memory (for example, a flash memory or other removable memory module) and memory slot, and other removable storage units and interfaces that allow software and data to be transferred from the removable storage unit 614 to the computing system 600.

The computing system 600 may also include a communications interface 618. The communications interface 618 may be used to allow software and data to be transferred between the computing system 600 and external devices. Examples of the communications interface 618 may include a network interface (such as an Ethernet or other NIC card), a communications port (such as for example, a USB port, a micro USB port), Near field Communication (NFC), etc. Software and data transferred via the communications interface 618 are in the form of signals which may be electronic, electromagnetic, optical, or other signals capable of being received by the communications interface 618. These signals are provided to the communications interface 618 via a channel 620. The channel 620 may carry signals and may be implemented using a wireless medium, wire or cable, fiber optics, or other communications medium. Some examples of the channel 620 may include a phone line, a cellular phone link, an RF link, a Bluetooth link, a network interface, a local or wide area network, and other communications channels.

The computing system 600 may further include Input/Output (I/O) devices 622. Examples may include, but are not limited to a display, keypad, microphone, audio speakers, vibrating motor, LED lights, etc. The I/O devices 622 may receive input from a user and also display an output of the computation performed by the processor 602. In this document, the terms “computer program product” and “computer-readable medium” may be used generally to refer to media such as, for example, the memory 606, the storage devices 608, the removable storage unit 614, or signal(s) on the channel 620. These and other forms of computer-readable media may be involved in providing one or more sequences of one or more instructions to the processor 602 for execution. Such instructions, generally referred to as “computer program code” (which may be grouped in the form of computer programs or other groupings), when executed, enable the computing system 600 to perform features or functions of embodiments of the present invention.

In an embodiment where the elements are implemented using software, the software may be stored in a computer-readable medium and loaded into the computing system 600 using, for example, the removable storage unit 614, the media drive 610 or the communications interface 618. The control logic (in this example, software instructions or computer program code), when executed by the processor 602, causes the processor 602 to perform the functions of the invention as described herein.

Thus, the disclosed method and system try to overcome the technical problem of generating fine-tuned code for Large Language Models (LLMs). The disclosed method and system may identify one or more Intellectual Property (IP) functions within a code in a code file. The code file is received as an input from a user. Upon identifying the one or more IP functions further, the disclosed method and system may flatten each of the one or more IP functions by replacing each of the one or more IP functions with a corresponding native reference code. The flattening of each of the one or more IP functions is iteratively performed until no IP function is left in the code. Further, the method and system may assign a unique identifier to the corresponding native reference code associated with each of the one or more IP function. Moreover, the disclosed method and system may generate a fine-tuned data file including the fine-tuned code corresponding to the code in the code file, in response to assigning.

As will be appreciated by those skilled in the art, the techniques described in the various embodiments discussed above are not routine, or conventional, or well understood in the art. The techniques try to overcome the technical problem of generating fine-tuned code for LLMs. The techniques may include distilling all aspects of the code into the training data while no IP function is explicitly shared. Further, fine-tuned code for LLM is agnostic to the language and environment in which the code is built and may scale to any size of the projects. Further, the working of the fine-tuned code generated will be as intended and may not include the IP functions and signature in the code.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for generating fine-tuned code for Large Language Models (LLMs). The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for generating fine-tuned code for Large Language Models (LLMs), the method comprising:
identifying, by a computing device, one or more Intellectual Property (IP) functions within a code in a code file, wherein the code file is received as an input from a user;
upon identifying the one or more IP functions, flattening, by the computing device, each of the one or more IP functions by replacing each of the one or more IP functions with a corresponding native reference code, wherein the flattening of each of the one or more IP functions is iteratively performed until no IP functions is left in the code;
assigning, by the computing device, a unique identifier to the corresponding native reference code associated with each of the one or more IP functions; and
generating, by the computing device, a fine-tuned data file comprising the fine-tuned code corresponding to the code in the code file, in response to assigning.

2. The method of claim 1, wherein identifying the one or more IP functions comprises
analyzing the code within the received code file based on at least one of a pre-processing technique and a configuration file.

3. The method of claim 1, wherein iteratively performing flattening of each of the one or more IP functions comprises:
analyzing each IP function of the one or more IP functions to identify one or more sub-IP functions within each IP function;
upon identifying the one or more sub-IP functions, flattening each of the one or more sub-IP functions by replacing each sub-IP function of the one or more sub-IP functions with a corresponding native reference code;
analyzing each sub-IP function of the one or more sub-IP functions to identify one or more subsequent sub-IP functions within each sub-IP function; and
upon identifying the one or more subsequent sub-IP functions, flattening each of the one or more subsequent sub-IP functions by replacing each subsequent sub-IP function of the one or more subsequent sub-IP functions with a corresponding native reference code.

4. The method of claim 1, further comprises:
identifying at least one of a comment or a document string associated with each IP function of the one or more IP functions; and
replacing each of the at least one of the comment or the document string with a corresponding native comment or a corresponding native document string respectively, in response to identifying.

5. The method of claim 1, further comprising utilizing the fine-tuned code within the fine-tuned data file for fine-tuning an LLM.

6. The method of claim 1, wherein the fine-tuned code corresponds to a generic code with no IP functions.

7. The method of claim 2, wherein the configuration file corresponding to the code file is generated by the user, and wherein the configuration file comprises domain specific information associated with components of a framework.

8. A system for generating fine-tuned code for Large Language models (LLMs), the system comprising:
a processor; and
a memory communicatively coupled to the processor, wherein the memory stores processor instructions, which when executed by the processor, cause the processor to:
identify one or more Intellectual Property (IP) functions within a code in a code file, wherein the code file is received as an input from a user;
upon identifying the one or more IP functions, flatten each of the one or more IP functions by replacing each of the one or more IP functions with a corresponding native reference code, wherein the flattening of each of the one or more IP functions is iteratively performed until no IP function is left in the code;
assign a unique identifier to the corresponding native reference code associated with each of the one or more IP functions; and
generate a fine-tuned data file comprising the fine-tuned code corresponding to the code in the code file, in response to assigning.

9. The system of claim 8, wherein to identify the one or more IP functions the processor instructions, on execution, cause the processor to,
analyze the code within the received code file based on at least one of a pre-processing technique and a configuration file.

10. The system of claim 8, wherein to iteratively perform flattening of each of the one or more IP functions the processor instructions, on execution, further cause the processor to:
analyze each IP function of the one or more IP functions to identify one or more sub-IP functions within each IP function;
upon identifying the one or more sub-IP functions, flatten each of the one or more sub-IP functions by replacing each sub-IP function of the one or more sub-IP functions with a corresponding native reference code;
analyze each sub-IP functions of the one or more sub-IP functions to identify one or more subsequent sub-IP functions within each sub-IP function; and
upon identifying the one or more subsequent sub-IP functions, flatten each of the one or more subsequent sub-IP functions by replacing each subsequent sub-IP function of the one or more subsequent sub-IP functions with a corresponding native reference code.

11. The system of claim 8, wherein the processor instructions, on execution, further cause the processor to:
identify at least one of a comment or a document string associated with each IP function of the one or more IP functions; and
replace each of the at least one of the comment or the document string with a corresponding native comment or a corresponding native document string respectively, in response to identifying.

12. The system of claim 8, wherein the processor instructions, on execution, further cause the processor to utilize the fine-tuned code within the fine-tuned data file for fine-tuning an LLM.

13. The system of claim 8, wherein the fine-tuned code corresponds to a generic code with no IP functions.

14. The system of claim 9, wherein the configuration file corresponding to the code file is generated by the user, and wherein the configuration file comprises domain specific information associated with components of a framework.

15. A non-transitory computer-readable medium storing computer-executable instructions for generating fine-tuned code for Large Language Models (LLMs), the computer-executable instructions configured for:
identifying one or more Intellectual Property (IP) functions within a code in a code file, wherein the code file is received as an input from a user;
upon identifying the one or more IP functions, flattening each of the one or more IP functions by replacing each of the one or more IP functions with a corresponding native reference code, wherein the flattening of each of the one or more IP functions is iteratively performed until no IP function is left in the code;
assigning a unique identifier to the corresponding native reference code associated with each of the one or more IP functions; and
generating a fine-tuned data file comprising the fine-tuned code corresponding to the code in the code file, in response to assigning.

16. The non-transitory computer-readable medium of claim 15, wherein for identifying the one or more IP functions the computer-executable instructions are further configured for
analyzing the code within the received code file based on at least one of a pre-processing technique and a configuration file.

17. The non-transitory computer-readable medium of claim 15, wherein for iteratively performing flattening of each of the one or more IP functions the computer-executable instructions are further configured for:
analyzing each IP function of the one or more IP functions to identify one or more sub-IP functions within each IP function;
upon identifying the one or more sub-IP functions, flattening each of the one or more sub-IP functions by replacing each sub-IP function of the one or more sub-IP functions with a corresponding native reference code;
analyzing each sub-IP function of the one or more sub-IP functions to identify one or more subsequent sub-IP functions within each sub-IP function; and
upon identifying the one or more subsequent sub-IP functions, flattening each of the one or more subsequent sub-IP functions by replacing each subsequent sub-IP function of the one or more subsequent sub-IP functions with a corresponding native reference code.

18. The non-transitory computer-readable medium of claim 15, wherein the computer-executable instructions are further configured for:
identifying at least one of a comment or a document string associated with each IP function of the one or more IP functions; and
replacing each of the at least one of the comment or the document string with a corresponding native comment or a corresponding native document string respectively, in response to identifying.

19. The non-transitory computer-readable medium of claim 15, wherein the computer-executable instructions are further configured for utilizing the fine-tuned code within the fine-tuned data file for fine-tuning an LLM.

20. The non-transitory computer-readable medium of claim 15, wherein the fine-tuned code corresponds to a generic code with no IP functions.
